(19) United States
(12) Patent Application Publication
(10) Pub. No.: US 2015/0099576 A1
(43) Pub. Date: Apr. 9, 2015

(54) DISTRIBUTION OF WAGERING GAME PLAYER REVENUES AND OFFER INCENTIVES

(71) Applicant: WMS Gaming, Inc., Waukegan, IL (US)

(72) Inventors: Peter R. Anderson, Glenview, IL (US); Andrew C. Guinn, Chicago, IL (US); Steven J. Lee, Elmhurst, IL (US); Jamie W. Vann, Chicago, IL (US); Larry J. Pacey, Northbrook, IL (US)

(21) Appl. No.: 14/508,841

(22) Filed: Oct. 7, 2014

Related U.S. Application Data
(60) Provisional application No. 61/887,869, filed on Oct. 7, 2013.

(51) Int. Cl. G07F 17/32

(52) U.S. Cl. CPC G07F 17/323; G07F 17/3244
USPC 463/25

(57) ABSTRACT

It is determined that a condition has been met for distributing revenue associated with offers made to wagering game players. Wagering game providers that are eligible to receive the revenue are determined by querying one or more electronic data stores. The amounts of revenue for each of the wagering game providers is determined. The amounts of revenue are distributed to the wagering game providers.

### RELATED APPLICATIONS

This application claims the priority benefit of U.S. Provisional Application Ser. No. 61/887,869 filed Oct. 7, 2013.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2014, WMS Gaming, Inc.

### FIELD

Embodiments of the inventive subject matter relate generally to wagering game systems, and more particularly to distributing revenue generated by wagering game systems.

### BACKGROUND

Wagering-game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering-game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering-game machine manufacturers to continuously develop new games and gaming enhancements that will attract frequent play.

Many players play wagering games at online gaming websites, and at bricks-and-mortar casinos. Casino operators want to attract online players to their casinos, while online gaming providers want to attract casino players to their online gaming sites.

### BRIEF DESCRIPTION OF THE FIGURES

Embodiments of the invention are illustrated in the Figures of the accompanying drawings in which:

FIG. 1 is a conceptual diagram depicting operations for selecting an available offer and providing the offer to an online gaming site, according to some embodiments

FIG. 2 is a conceptual diagram depicting an example revenue-sharing system for online gaming providers and casinos, according to some embodiments.

FIG. 3 is a block diagram illustrating a wagering-game machine architecture, according to example embodiments of the invention.

FIG. 4 is a block diagram illustrating a wagering game network 400, according to example embodiments of the invention.

FIG. 5 is a block diagram illustrating an offer server and revenue-tracking server machine architecture, according to example embodiments of the invention.

FIG. 6 is a block diagram illustrating an online wagering game network 600, according to example embodiments of the invention.

FIG. 7 depicts example operations for selecting an offer for display on an online gaming site or wagering-game machine at a casino.

FIG. 8 depicts example operations for distributing and disbursing player revenue among associated entities.

### DESCRIPTION OF THE EMBODIMENTS

This description of the embodiments is divided into five sections. The first section provides an introduction to embodiments of the invention, while the second section describes example wagering-game machine architectures. The third section describes example operations performed by some embodiments and the fourth section describes example wagering-game machines in more detail. The fifth section presents some general comments.

### Introduction

This section provides an introduction to some embodiments of the invention.

Sometimes various gaming entities can develop mutually beneficial relationships with each other. In one such relationship, a casino may make offers (e.g., give coupons, free game credits, etc.) that encourage casino players to spend money at online wager gaming websites. In return, the online gaming providers can distribute a portion of revenues derived from the casino players on the online wager gaming websites to the casino. Likewise, online gaming providers can encourage online players to go play in certain casinos. Some embodiments of the inventive subject matter include methods and components for sharing revenue between a plurality of wagering game providers, such as casino operators and online wager gaming website operators. For example, some embodiments include components that make offers to players, track when the offers are redeemed, and facilitate revenue sharing between wager gaming entities. The following discussion provides more details about how online gaming sites and casinos can mutually benefit each other by encouraging players to participate in wagering games offered by the other entities.

In some embodiments, an online wagering-game server is associated with an online gaming site. The online wagering-game server can provide wagering-game content over the internet to online players (e.g., players connected via computers). Along with the wagering-game content, the online wagering-game server (“online server”) can provide offers or advertisements (“offers”) associated with brick-and-mortar casinos (“casinos”). The offers are tailored to particular players based on various demographic data, casino associations, etc. For example, the online server may offer a player discounted game play at a casino located near the player. When a player accepts or otherwise acts on an offer, the online gaming site receives an amount of the revenue associated with the offer, thus compensating the online gaming site for displaying the offer to the player. The online server can determine how revenues are to be distributed, such as by determining how revenue received from the player should be divided between the online gaming site and the casino.

In some instances, the online server may determine that the player spends an above average amount of money at the online gaming site (compared to other players), and thus determines that the player should be shown offers related to a casino that caters to players who spend relatively more money than other players. Further, the online server may determine that the player has a previously established relationship with casino A, and thus may determine that the player should be shown an offer for casino A.

When a player accepts or otherwise acts on an offer, the online server determines the proper revenue share between the participating entities (e.g., the online gaming site and casino A) based on the revenue earned from the player. The online server can also determine the proper revenue share prior to any offer acceptance or action. The online server can determine the revenue share based on a variety of factors, such as whether the player has a previously established relationship with an entity (e.g., casino A), the type of offer, etc. Some offers may not relate to receiving an amount of revenue, but instead relate to receiving some other value. In some embodiments, the online server can determine what value the online gaming site receives in return for revenues associated with offers presented on the online gaming site.

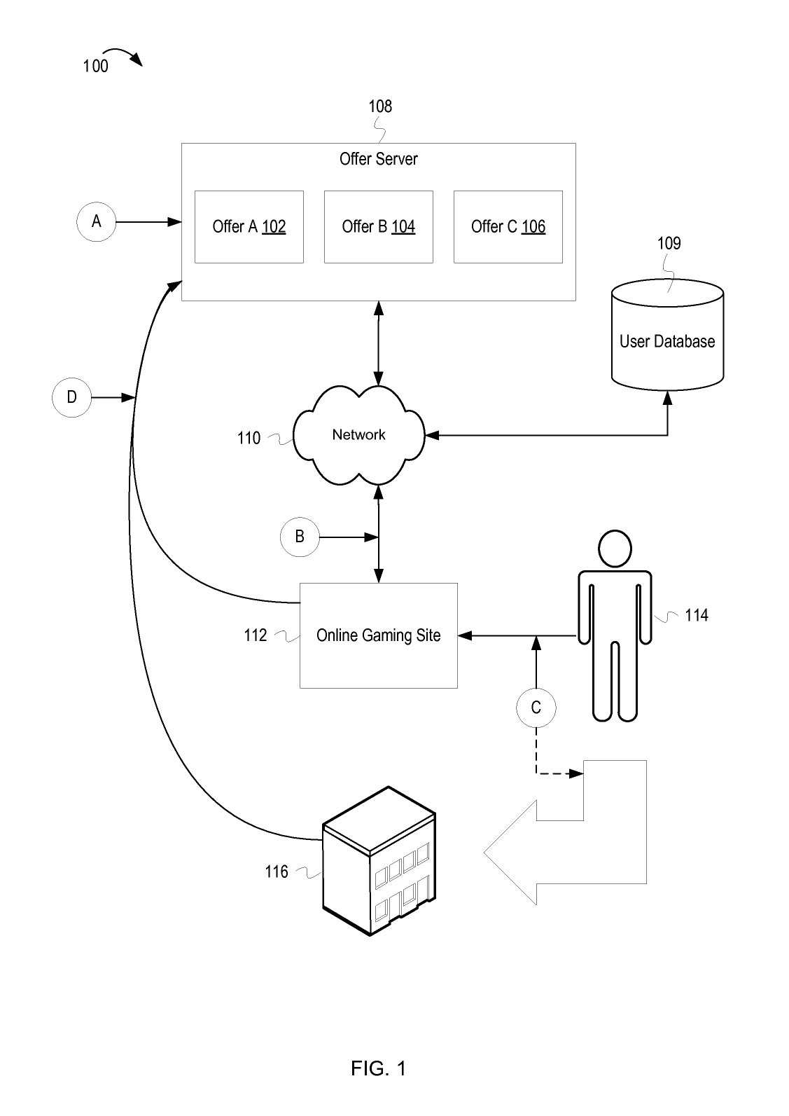

In some embodiments, a casino server provides wagering-game content to a particular wagering-game machine, such as a video slot machine. Along with the wagering-game content, the casino server provides offers for an online gaming site. The offers can be tailored to the particular player based on factors similar to those described above. If the player acts on an offer for the online gaming site, the casino server can determine an appropriate amount of revenue to distribute from the casino to the online gaming site. Thus, for example, if the player purchases twenty dollars in game play credits on the online gaming site, the online gaming site might pay the casino a percentage of the twenty dollars. For offers that have other types of incentives, the server can determine the incentive due to the casino as appropriate for the particular type of incentive. FIG. 1 shows additional details about some embodiments. This discussion continues with a description of FIG. 1.

FIG. 1 is a conceptual diagram depicting operations for selecting an available offer and providing the offer to an online gaming site, according to some embodiments. FIG. 1 depicts an offer-serving system 100, an offer server 108 and an online gaming site 112. The offer server 108 is communicatively coupled with the online gaming site 112 through a network 110. FIG. 1 also depicts a player database that is communicatively coupled with the offer server 108 through the network 110. The offer server 108 selects an offer from a set of three offers, offer A 102, offer B 104, and offer C 106. The offer server 108 serves the selected offer to the online gaming site 112. The online gaming site 112 then displays the offer to a player 114 who is accessing the online gaming site 112. The selected offer, and possibly other unselected offers, is associated with a casino 116.

At stage A, the offer server 108 selects an offer to serve. The offer server 108 can select an offer based on many different factors, such as demographic data related to the player 114, previously established relationships with casinos associated with the offers, historical offer-acceptance data, random selection, etc. The data relied upon by the offer server 108, if any, can be stored in the player database 109 or similar databases, servers, etc. The offer server 108 can query the player database 109 for data related to the player 114. After retrieving the data used to select an offer, the offer server 108 determines which offer to serve.

In some implementations, the offer server 108 can determine which offer to serve based solely on a random selection from the available offers. However, offers can be targeted to the player 114 by utilizing available data. For example, demographic data associated with the player 114 can include the player's location, the amount of money the player 114 has spent on the online gaming site 112, the types of games the player 114 plays, etc. Each offer can include data that allows the offer server 108 to select the best offer based on the player's demographic data. For example, the player database 109 can indicate that the player 114 tends to play video poker games instead of slots games. The offer server 108 can use the information indicating that the player 114 tends to play video poker games to determine that offer B 104, an offer related to video poker, is more relevant to the player 114 than an offer related to video slots. If offer A 102 is for a casino that is one thousand miles away from the player 114, while offer C 106 is for a casino that is twenty miles away from the player 114, the offer server 108 may determine that offer C 106 is more relevant to the player 114 than offer A 102.

Offers can be selected based on the player's offer acceptance history or other player activity data. For example, if the player 114 tends to accept a particular class or type of offer over other offers, the offer server 108 may be more likely to select an offer of the class or type that the player 114 tends to accept. Examples of offer classes or types include coupons, free play offers, deals on non-gaming related services, etc. Additionally, the offer server 108 can select an offer based on incentives provided by a casino associated with the particular offer. For example, casino A may offer a ten dollar payment for each player that accepts an offer for casino A, while casino B may offer a twenty dollar payment for each player that accepts an offer for casino B. The offer server 108 might select the offer associated with casino B because of the greater incentive offered.

Offers can also be targeted based on a relationship between the player 114 and the casinos associated with the offers. For example, the player 114 may have a previously established relationship with the casino 116 and offer C 106 may be associated with the casino 116. Thus, the offer server 108 can evaluate all three offers and select offer C 106 based on the previously established relationship between the player 114 and the casino 116.

Some embodiments can employ additional techniques and/or combine various techniques to select an offer. For example, the offer server 108 might narrow down the available offers to a subset based on the demographics of the player 114, such as restricting offers to those for casinos within two hundred miles. The offer server 108 might further narrow down the available offers based on predicted offer-acceptance rates, generated from the player's offer acceptance history. From the subset of available offers, the offer server 108 might then select the offer that includes the largest incentive.

The offer server 108 can also communicate with servers associated with the casinos to determine which offer should be selected. For example, the offer server 108 may transmit the player's demographic data to each casino that has an offer available. The casinos can then respond by indicating the value of an incentive based on how much the player 114 is “worth” to the respective casino. The offer server 108 can then select the offer with the largest incentive or utilize additional techniques to determine which offer to select, as described above.

Offers can come in a variety of forms. For example, offers can be basic advertisements that indicate the name of a particular casino without providing a particular incentive to the player 114. Offers can be advertisements that indicate current promotions available at a casino or include coupons or other deals that target specific players based on demographic data, etc. Offers can include redemption requirements limited to specific machines or include other, non-gaming related activities, such as concerts or spa packages.

At stage B, the offer server 108 provides the selected offer to the online gaming site 112. The online gaming site 112, in turn, displays the selected offer to the player 114. The selected offer is then displayed by the online gaming site 112. The online gaming site 112 can display the selected offer in a variety of ways. In some embodiments, the selected offer is displayed as an advertisement placed somewhere around the perimeter of the wagering game being played by the player 114. In some embodiments, the selected offer is displayed either over the wagering game being played or during a transition between plays or wagering games. In some embodiments, the selected offer is displayed during a particular play, such as hiding the activity of the game until the selected offer is dismissed or accepted. The selected offer can also be displayed on a non-wagering game page, such as a homepage, an offers page, or a profile page. Various other techniques of displaying the selected offer may be used as well. Further, the selected offer may be one of multiple offers that are selected by the offer server 108, provided to the online gaming site 112, and displayed to the player 114.

At stage C, the player 114 accepts the selected offer. Acceptance can be indicated in a variety of ways. For example, the selected offer can include a link to a particular page (such as an “offer page”). The selected offer can be accepted by clicking on the link and opening the offer page, at which point the online gaming site 112 qualifies for the incentive related to the selected offer. In some embodiments, a selected offer is redeemed when a player makes a purchase related to the selected offer. For example, the selected offer might be a coupon for ten dollars off a twenty dollar activity, and the selected offer is accepted when the player 114 pays the ten dollars for the activity. Similarly, the selected offer might include a specific coupon code that is indicated when the player 114 redeems the selected offer. When the selected offer is redeemed by the player 114 and the coupon code is indicated, the selected offer is considered accepted. Thus, some offers are accepted at the casino 116.

Some implementations can allow more than one acceptance technique. For example, in some implementations, the online gaming site 112 may only allow offers that are accepted by clicking on the displayed offer. In some implementations, the online gaming site 112 may allow both offers that are accepted by clicking on the displayed offer and offers that are accepted by redeeming a coupon at a casino. In implementations with only one acceptance technique, the offer server 108 only selects, or is only given access to, offers that conform to the particular acceptance technique allowed. In implementations with more than one acceptance technique, the offers can specify the particular technique applicable or the applicable technique can be implicit based on the type or class of offer. For example, a “coupon” class of offers may be defined as offers that include a coupon code that is redeemed by the player 114. If the particular implementation restricts the acceptance technique to those with coupon codes, the offer server 108 may only select offers that are part of the “coupon” class, thus implicitly restricting the acceptance technique based on the class of the offer.

In some implementations, offers can be deemed accepted through implicit action by the player 114. For example, the player 114 can be associated with a form of identification known both to the online gaming site 112 and the casino 116. For example, the player 114 might be part of a loyalty program at the casino 116. The identification used to identify the player 114 for the purposes of the loyalty program at the casino 116 can be provided to the online gaming site 112. The online gaming site 112 can indicate that a particular offer for the casino 116 was served to the player 114. If the player 114 participates in the loyalty program within a certain time period, for example, the offer can be deemed to be implicitly accepted.

At stage D, the online gaming site 112 or the casino 116 indicates to the offer server 108 that an offer has been accepted. By indicating to the offer server 108 that the offer has been accepted, the online gaming site 112 and casino 116 allows the offer server to record identification data for the player 114, information about which offer was accepted, etc. The recorded information allows the offer server 108 or other computing systems to determine how the values of incentives associated with the accepted offer are determined. Although depicted as communicating directly with the offer server 108 at stage D, the online gaming site 112 and the casino 116 can communicate with the offer server 108 through the network 110. Further, in some embodiments, if the online gaming site 112 determines that the offer is accepted, the online gaming site 112 or offer server 108 notifies the casino 116 that the offer was accepted and provides any appropriate identifying data. If the casino 116 notifies the offer server 108 of the offer acceptance, the casino 116 may store related identifying data, and may query the offer server 108 for additional data. Storing identifying data facilitates the casino's ability to determine the proper amount of revenue distributed or incentives owed to the online gaming site 112.

While the player database 109 is depicted as being communicatively coupled with the offer server 108 through the network 110, the player data database 109 can be communicatively coupled with the offer server 108 directly, or can be combined with the offer server 108. Furthermore, while the player database 109 is the only database depicted, many other databases can be utilized to store data. The offer server 108 can query other databases similarly to querying the player database 109. The offer server 108 can also utilize data sources other than databases.

As described above, in some embodiments a server providing content to a wagering-game machine at a casino provides offers for an online gaming site. The operations depicted in FIG. 1 can be adapted to illustrate such a system. In such a system, the wagering-game machine is analogous to the online gaming site 112, while the online gaming site 112 is analogous to the casino 116. Thus, the offer server 108 serves offers to a wagering-game machine instead of to the online gaming site 112. The player 114 can accept an offer displayed on a wagering-game machine by performing actions such as setting up an account associated with the online gaming site 112, signing into a previously created account on the online gaming site 112, or redeeming a coupon on the online gaming site 112, as well as performing actions similar to those described above. The offers in such an embodiment can be similar to the offers available to the player 114 when on the online gaming site 112.

In some embodiments, the offer server 108 can be a standalone server such that the offer server's only function is to select and serve offers. In some embodiments, the offer server 108 can be combined with another server or include other functionality, such as serving wagering-game content. In some embodiments, the offer server 108 can be a hardware server. In some embodiments the offer server 108 can be a software server that runs on a hardware server or other computing system.

Further, while a casino is described as a “brick-and-mortar casino”, a casino can be any physical location that offers access to wagering-game machines. For example, a casino need not be limited to a building on land, but can also be a water-based ship or an airplane. Wagering-game machines can be implemented to display content that is the same or similar to content on an online gaming site. However, an online gaming site is designed to be accessed by devices that operate outside casinos.

It should be noted that wagering games also include games in which wagering does not involve monetary value. For example, some wagering games can use “play money” that does not have any value outside of the game. Further, the incentives and other concepts described herein are not limited to wagering games. For example, an offer could be for free play associated with an online roleplaying game. Other types of games include action games, strategy games, sports games, etc.

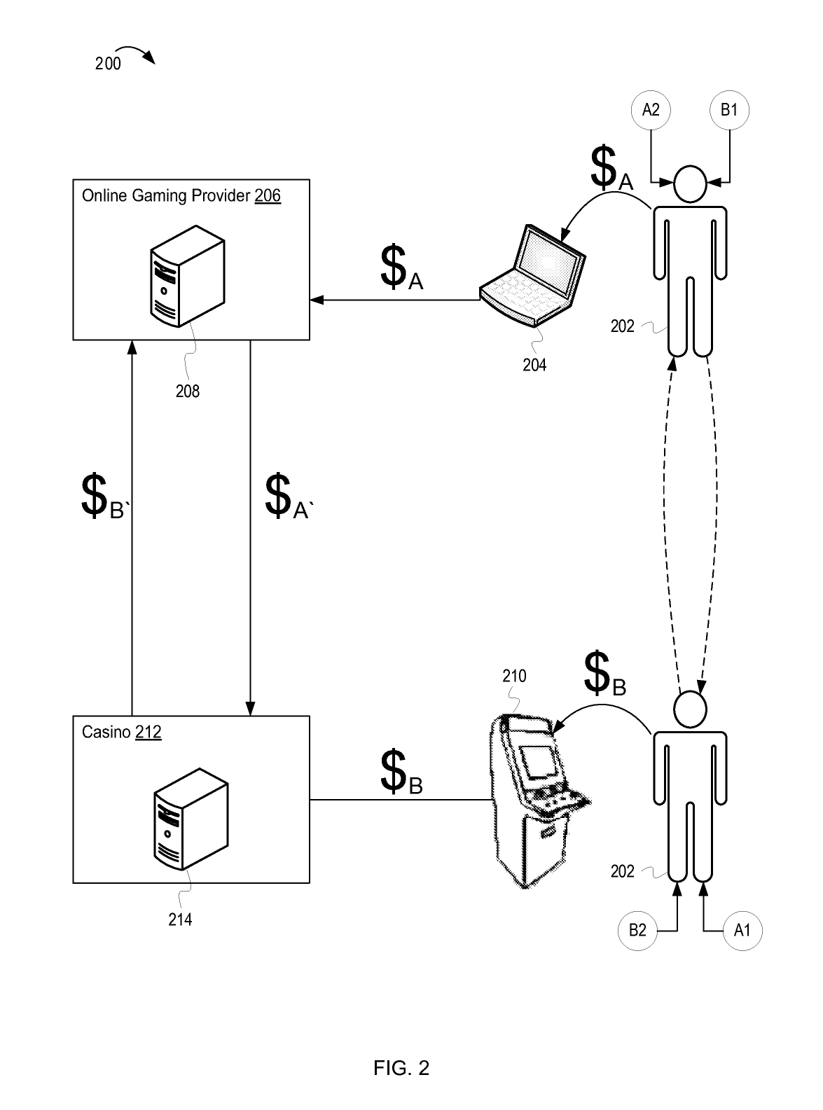

FIG. 2 is a conceptual diagram depicting an example revenue-sharing system for online gaming providers and casinos, according to some embodiments. FIG. 2 depicts a revenue-sharing system 200, including an online gaming provider 206 and a casino 212. FIG. 2 also depicts a computer 204, a wagering-game machine 210, and a player 202. The online gaming provider includes an online revenue-tracking-and-distribution server (hereinafter “online revenue-tracking server”) 208 and the casino 212 includes a casino revenue-tracking-and-distribution server (hereinafter “casino revenue-tracking server”) 214. The revenue-tracking servers 208 and 214 embody a subset of the functionality of the offer server 108 depicted in FIG. 1. The online and casino revenue-tracking servers 208 and 214 can be implemented as individual servers or combined with offer serving functionality to comprise the offer server 108. FIG. 2 also depicts scenarios A and B, indicated by the letters “A” and “B”, respectively.

At step A1 of scenario A, the player 202 accepts an offer displayed on the wagering-game machine 210 for an online gaming site provided by the online gaming provider 206. The offer can be served and accepted in a substantially similar manner to the embodiments described herein. In this particular example, after the player 202 accepts the offer, the online gaming provider 206 is notified that the offer has been accepted, as described above.

At step A2 of scenario A, the player 202 deposits money to play wagering games provided on an online gaming site by the online gaming provider 206. The money paid by the player 202 at step A2 is indicated in FIG. 2 by the “$_{A}” labels. The player 202 enters payment information into their computer 204, which transmits payment to the online gaming provider 206. When the online gaming provider 206 verifies the availability of the money, the gaming provider gives the player 202 access to the online gaming site to play wagering games. In some embodiments, the online gaming provider 206 provides functionality that allows the player 202 to store monetary value on the online gaming site (such as allowing the player 202 to purchase and store game credits). Thus, the player 202 may already have money stored on the online gaming site, and may begin playing wagering games without entering payment information.

After the player 202 accepts the offer at stage A1, the online gaming provider 206 receives identifying data associated with the offer and the player 202, as described above. The online gaming provider 206 can also query the casino 212 for additional identifying data. For example, the online gaming provider 206 can query the casino revenue-tracking server 214 to obtain the identifying data. The identifying data can include the identity of the player 202, the particular offer that was accepted, the identity of the casino 212, etc. The identifying data can be stored on the online revenue-tracking server 208. The online gaming provider 206 utilizes this identifying data to determine how much revenue the online gaming provider 206 owes the casino 212 as payment for the player's acceptance of the offer. The identifying data can be used by the online revenue-tracking server 208 in conjunction with data pertaining to the player's gameplay to determine the specific amount of revenue the online gaming provider 206 owes the casino 212.

For example, the particular offer may have a flat-rate incentive, in which the casino 212 accrues a specific amount of revenue for each offer accepted. Thus, the online gaming provider 206 can utilize the identifying data to determine which offer was accepted and which casino 212 the offer was generated from, allowing for the online gaming provider 206 to pay the appropriate amount of revenue to the casino 212. The offer may include a revenue-share incentive, in which the casino 212 receives a percentage of the money spent by the player 202 at the online gaming provider 206. The percentage paid to the casino 212 may differ from the percentage paid to a different casino. Thus, the identifying data allows the online gaming provider 206 to pay an appropriate amount of revenue based on the identity of the casino 212.

FIG. 2 also illustrates a money transfer from the online gaming provider 206 to the casino 212 in payment of an offer incentive. In FIG. 2, the “$_{A′},” illustrates the amount transferred. For example, if the offer included a flat-rate incentive, such as twenty-five dollars, the online gaming provider 206 would transfer twenty-five dollars to the casino 212 upon acceptance of the offer (or, in some embodiments, upon the player meeting the threshold condition of the offer, such as wagering $50 within the online gaming site). If the offer included a percentage incentive of ten percent based on the amount of money spent by the player 202 and the player 202 spent one hundred dollars, the online gaming provider 206 would transfer ten dollars to the casino 212 for every one hundred dollars wagered by the player. In other embodiments, the player's net losses (i.e., the online gaming provider's 206 net win) could be tracked, and the casino 212 would receive a distribution based on a revenue-sharing model associated with the player's losses (e.g., the losses could be split 50/50 between the online gaming provider 206 and the casino 212). The transfer of money or other value from the online gaming provider 206 to the casino 212 can be effectuated by the online revenue-tracking server 208, and can include the online revenue-tracking server 208 communicating with the casino revenue-tracking server 214.

At step B1 of scenario B, the player 202 accepts an offer displayed on an online gaming site provided by the online gaming provider 206. The offer is related to a location associated with the casino 212. The offer can be served and displayed in a substantially similar manner to the embodiments described herein. In this particular example, when the player 202 accepts the offer, the casino 212 is notified that the offer has been accepted, as described above. For example, the online gaming provider 206 can notify the casino 212 by communicating with the casino revenue-tracking server 214.

At step B2 of scenario B, the player 202 accepts the offer and pays money to the casino 212. The payment of money can occur at the same time as, or after acceptance of the offer. For example, the player 202 may accept an offer by prepaying ten dollars in return for twenty dollars of future gameplay on the wagering-game machine 210. The player 202 may accept an offer by putting a coupon code into the wagering-game machine 210, along with a specified amount of money.

As illustrated in FIG. 2, the player 202 pays the casino 212 by interacting with the wagering-game machine 210 (illustrated by the “$_{B}” labels). As described above, the specific method of revenue sharing can vary between offers. For example, some offers may include a flat-rate incentive while others may include a percentage-based revenue share, or a combination thereof. The casino 212 determines the amount of revenue owed to the online gaming provider 206, and transfers the appropriate amount to the online gaming provider 206, as indicated by the “$_{B},” label.

While this discussion describes the transfer and/or movement of money, no actual money may change hands during the time periods described in these example embodiments. For example, when the player 202 pays the online gaming provider 206 to access the online gaming site, the player 202 may provide the online gaming provider 206 with the player's credit card information. The online gaming provider 206 may then charge the player's credit card the appropriate amount of money. The credit card company may indicate that the charge is approved without actually transferring money to the online gaming provider 206. Instead, the credit card company may transfer the money owed to the online gaming provider 206 on a periodic basis, such as monthly. Similarly, money transferred between the online gaming provider 206 and the casino 212 may not be transferred in real-time. Thus, the online gaming provider 206 and the casino 212 may operate based on indications of money transfers or transactions, relying on periodic transfers or invoicing to actually exchange money.

Relatedly, while FIG. 2 illustrates embodiments in which the player 202 accepts an offer at one provider and pays money at the other provider, embodiments are not so limited. For example, as described above, some offers may be accepted by the payment of money, such as paying ten dollars for a coupon worth twenty dollars of gameplay. In such a scenario, the payment of money might be to the entity displaying the offer, instead of to the offering entity. Thus, in some implementations, instead of accepting an offer displayed by the online gaming provider 206 and paying money to the casino 212, the offer may be displayed by and money paid to the online gaming provider 206. In such implementations, instead of the offering entity accepting the money and determining the revenue due to the referring entity, the referring entity determines the revenue due to the offering entity. In general, the various ways in which the money travels between entities can vary between implementations, and not all permutations are described herein.

Although FIGS. 1 and 2 describe some embodiments, the following sections describe many other embodiments.

### Operating Environment

This section describes an example operating environment and presents structural aspects of some embodiments. This section includes discussion about wagering-game machine architectures, wagering game networks, offer server machine architectures, and online wagering game networks.

### Wagering-Game-Machine Architectures

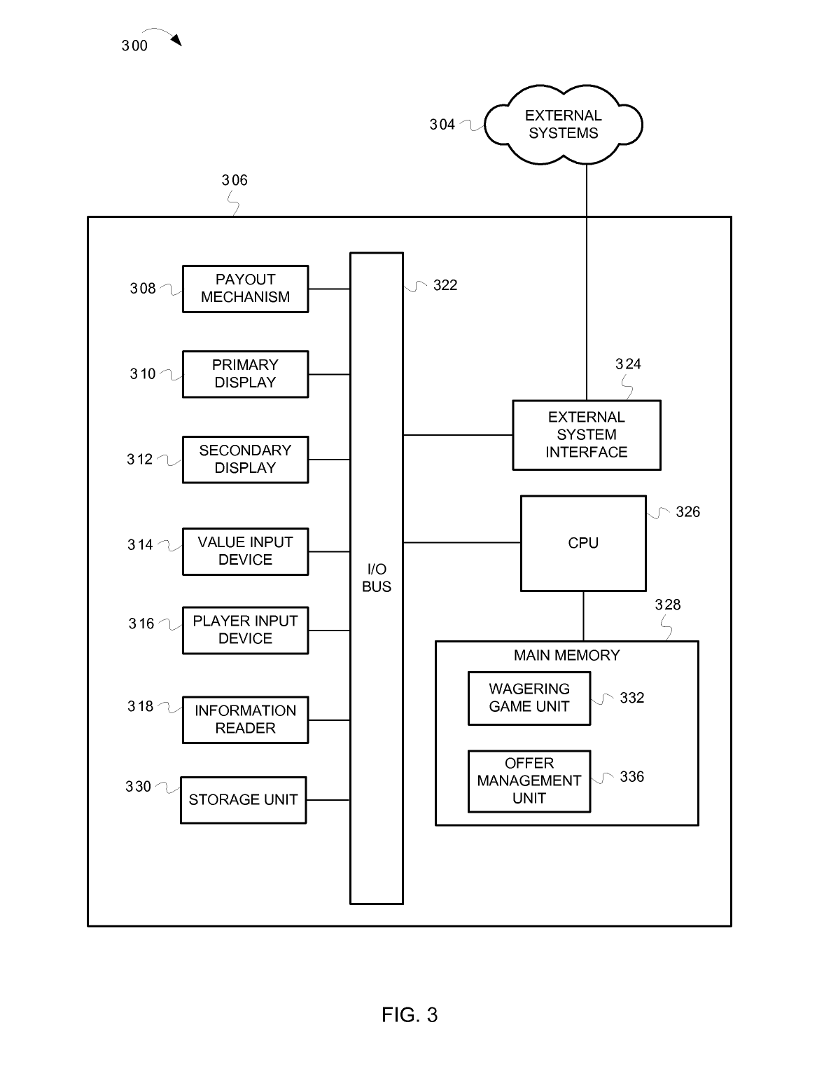

FIG. 3 is a block diagram illustrating a wagering-game machine architecture, according to example embodiments of the invention. As shown in FIG. 3, the wagering-game machine architecture 300 includes a wagering-game machine 306, which includes a central processing unit (CPU) 326 connected to main memory 323. The CPU 326 can include any suitable processor, such as an Intel® Pentium processor, Intel® Core 2 Duo processor, AMD Opteron™ processor, or UltraSPARC processor. The main memory 323 includes a wagering game unit 332 and an offer management unit 336. In some embodiments, the wagering game unit 332 can present wagering games, such as video poker, video black jack, video slots, video lottery, etc., in whole or part. In some embodiments, the offer management unit 336 can present offers and determine when an offer is accepted.

The CPU 326 is also connected to an input/output (I/O) bus 322, which can include any suitable bus technologies, such as an AGTL+frontside bus and a PCI backside bus. The I/O bus 322 is connected to a payout mechanism 303, primary display 310, secondary display 312, value input device 314, player input device 316, information reader 313, and storage unit 330. The player input device 316 can include the value input device 314 to the extent the player input device 316 is used to place wagers. The I/O bus 322 is also connected to an external system interface 324, which is connected to external systems 304 (e.g., wagering game networks).

In one embodiment, the wagering-game machine 306 can include additional peripheral devices and/or more than one of each component shown in FIG. 3. For example, in one embodiment, the wagering-game machine 306 can include multiple external system interfaces 324 and/or multiple CPUs 326. In one embodiment, any of the components can be integrated or subdivided.

Any component described herein can include hardware, firmware, and/or machine-readable storage devices including instructions for performing the operations described herein. Machine-readable storage devices include any mechanism that stores and transmits information in a form readable by a machine (e.g., a wagering-game machine, computer, etc.). For example, machine-readable devices includes read only memory (ROM), random access memory (RAM), magnetic disk storage media, optical storage media, flash memory machines, etc. Machine readable storage devices can include media suitable for storing information, such as optical media, magnetic media, etc.

While FIG. 3 describes an example wagering-game machine architecture, this section continues with a discussion of wagering game networks.

### Wagering Game Networks

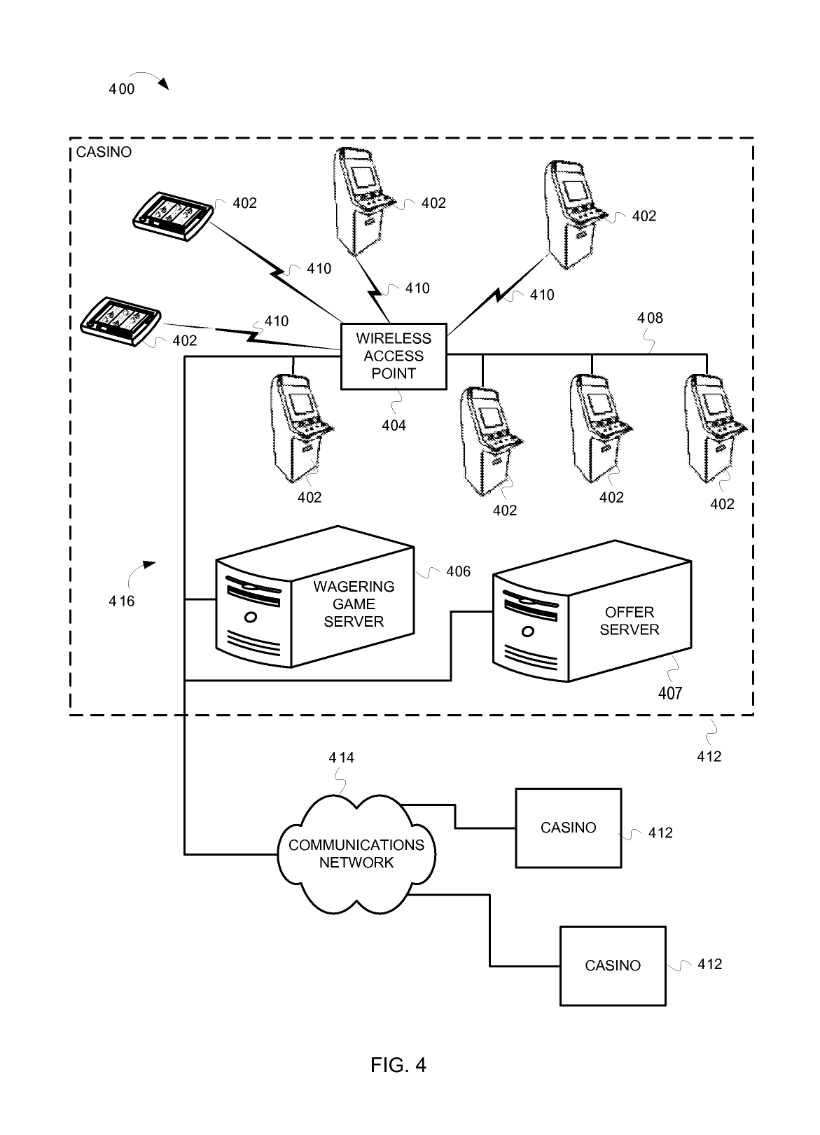

FIG. 4 is a block diagram illustrating a wagering game network 400, according to example embodiments of the invention. As shown in FIG. 4, the wagering game network 400 includes a plurality of casinos 412 connected to a communications network 414.

Each casino 412 includes a local area network 416, which includes an access point 404, a wagering game server 406, an offer server 407, and wagering-game machines 402. The access point 404 provides wireless communication links 410 and wired communication links 408. The wired and wireless communication links can employ any suitable connection technology, such as Bluetooth, 802.11, Ethernet, public switched telephone networks, SONET, etc. In some embodiments, the wagering game server 406 can serve wagering games and distribute content to devices located in other casinos 412 or at other locations on the communications network 414.

The wagering-game machines 402 described herein can take any suitable form, such as floor standing models, handheld mobile units, bartop models, workstation-type console models, etc. Further, the wagering-game machines 402 can be primarily dedicated for use in conducting wagering games, or can include non-dedicated devices, such as mobile phones, personal digital assistants, personal computers, etc. In one embodiment, the wagering game network 400 can include other network devices, such as accounting servers, wide area progressive servers, player tracking servers, and/or other devices suitable for use in connection with embodiments of the invention.

In some embodiments, wagering-game machines 402 and wagering game servers 406 work together such that a wagering-game machine 402 can be operated as a thin, thick, or intermediate client. For example, one or more elements of game play may be controlled by the wagering-game machine 402 (client) or the wagering game server 406 (server). Game play elements can include executable game code, lookup tables, configuration files, game outcome, audio or visual representations of the game, game assets or the like. In a thin-client example, the wagering game server 406 can perform functions such as determining game outcome or managing assets, while the wagering-game machine 402 can present a graphical representation of such outcome or asset modification to the user (e.g., player). In a thick-client example, the wagering-game machines 402 can determine game outcomes and communicate the outcomes to the wagering game server 406 for recording or managing a player's account.

In some embodiments, either the wagering-game machines 402 (client) or the wagering game server 406 can provide functionality that is not directly related to game play. For example, account transactions and account rules may be managed centrally (e.g., by the wagering game server 406) or locally (e.g., by the wagering-game machine 402). Other functionality not directly related to game play may include power management, presentation of advertising, software or firmware updates, system quality or security checks, etc.

In some embodiments, the offer server 407 can provide functionality that facilitates the selection, display and management of offers. For example, the wagering-game machines 402 can request offers to display from the offer server 407. The offer server 407 can select offers and provide offer data to the wagering-game machines 402. The wagering-game machines 402 can also indicate that an offer has been accepted, notifying the offer server 407. The offer server 407 can store various data about displayed and/or accepted offers. In some embodiments, the wagering game server 406 provides the functionality of the offer server 407. Further, in some embodiments, the offer server 407 can include the functionality of a revenue-tracking server either alone or in conjunction with the functionality of an offer server.

Any of the wagering game network components (e.g., the wagering-game machines 402) can include hardware and machine-readable media including instructions for performing the operations described herein.

While FIG. 4 describes an example wagering game network, this section continues with a discussion of offer server machine architectures.

### Offer Server and Revenue-tracking Server Machine Architectures

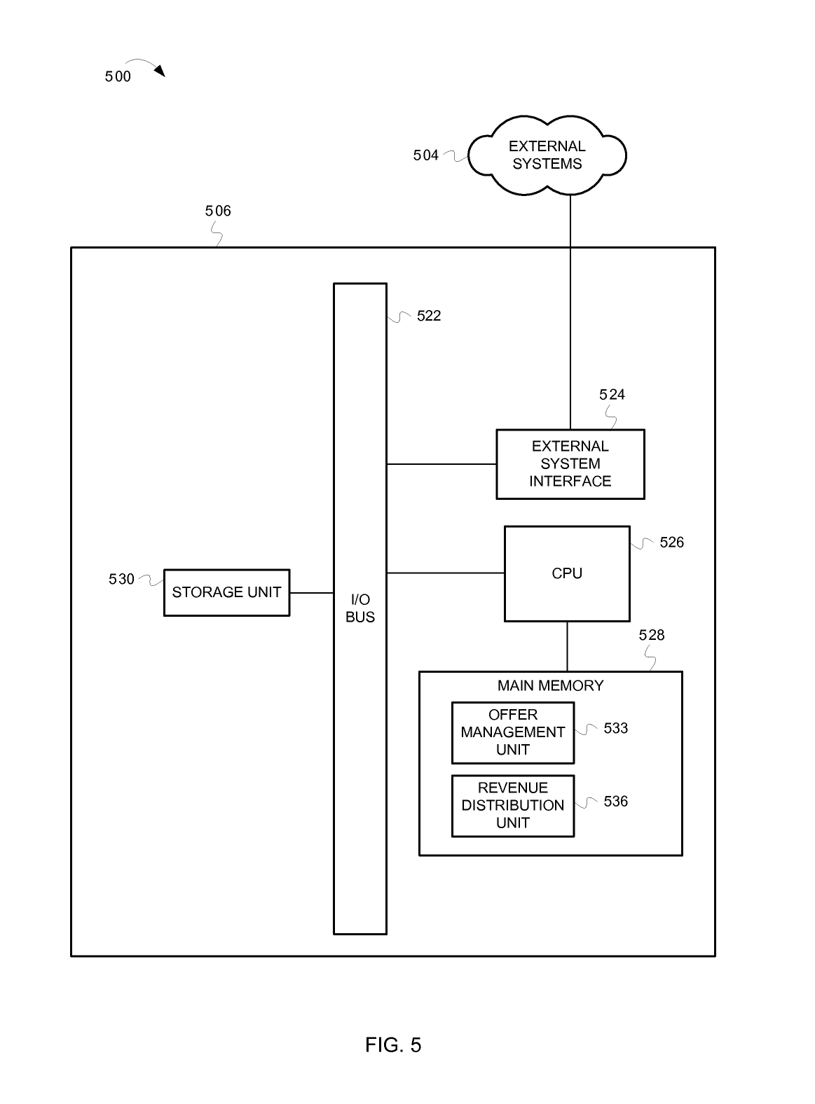

FIG. 5 is a block diagram illustrating an offer server and revenue-tracking server machine architecture, according to example embodiments of the invention. As shown in FIG. 5, the offer server and revenue-tracking server machine architecture (hereinafter “offer server machine architecture”) 300 includes an offer server machine 506, which includes a central processing unit (CPU) 526 connected to main memory 523. The CPU 526 can include any suitable processor, such as an Intel® Pentium processor, Intel® Core 2 Duo processor, AMD Opteron™ processor, or UltraSPARC processor. The main memory 523 includes an offer management unit 533 and a revenue distribution unit 536. In some embodiments, the offer management unit 533 can select offers from a set of offers, indicate that selected offers should be displayed, and store data about offers. In some embodiments, the revenue distribution unit 536 can determine to what entities revenue should be distributed, update the amount of revenue due to each entity, and disburse revenue to entities.

The CPU 526 is also connected to an input/output (I/O) bus 522, which can include any suitable bus technologies, such as an AGTL+frontside bus and a PCI backside bus. The I/O bus 522 is connected to a storage unit 530. The I/O bus 522 is also connected to an external system interface 524, which is connected to external systems 504 (e.g., wagering game networks).

In one embodiment, the offer server machine 506 can include additional peripheral devices and/or more than one of each component shown in FIG. 5. For example, in one embodiment, the offer server machine 506 can include multiple external system interfaces 524 and/or multiple CPUs 526. In one embodiment, any of the components can be integrated or subdivided.

While FIG. 5 describes an example offer server machine architecture, this section continues with a discussion of online wagering game networks.

### Online Wagering Game Networks

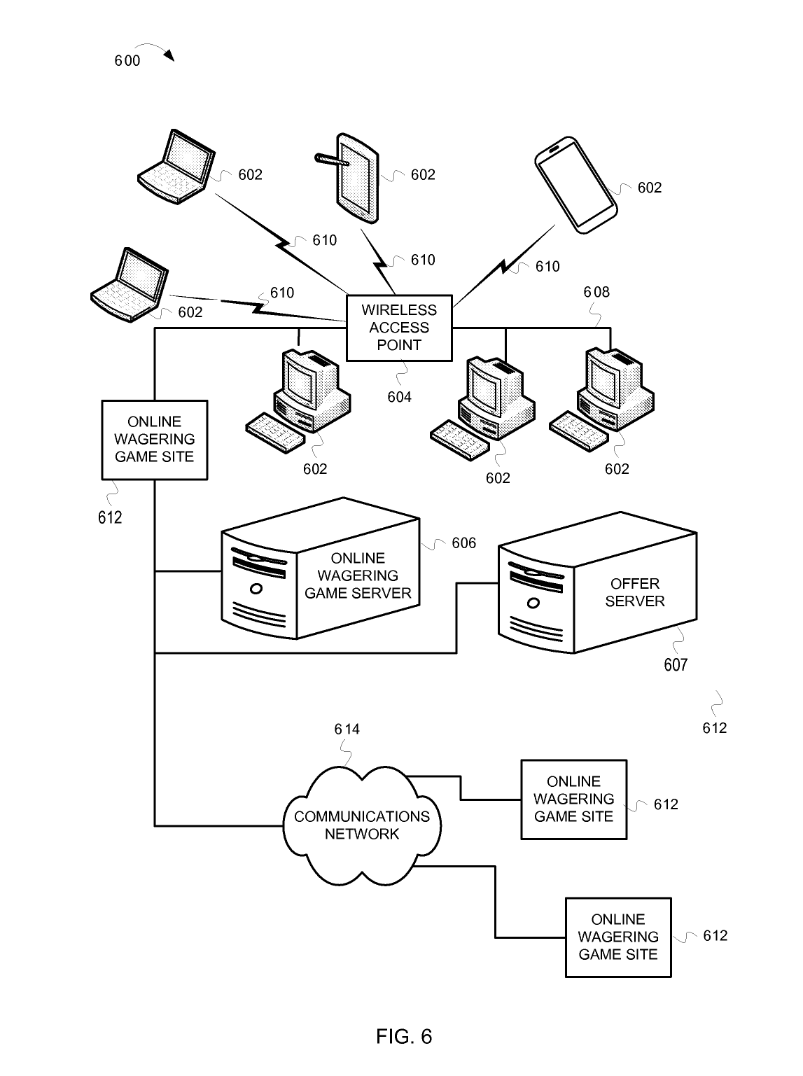

FIG. 6 is a block diagram illustrating an online wagering game network 600, according to example embodiments of the invention. As shown in FIG. 6, the online wagering game network 600 includes a plurality of online gaming sites 612 connected to a communications network 614.

Each online gaming site 612 is connected to a plurality of computing systems 602. The plurality of computing systems can comprise any type of computing system, such as a desktop computer, a laptop computer, a tablet computer and a smartphone. One or more of the plurality of computing systems 602 can be connected through a wireless access point 604. The wireless access point 604 can also be a cellular tower or other component of a cellular network. The access point 604 provides wireless communication links 610 and wired communication links 608. Each online gaming site 612 is also connected to an online wagering-game server 606 and an offer server 607. The wired and wireless communication links can employ any suitable connection technology, such as Bluetooth, 802.11, Ethernet, public switched telephone networks, SONET, etc. In some embodiments, the online wagering-game server 606 can serve online wagering games and distribute content to other online gaming sites 612 or at other locations on the communications network 614.

In some embodiments, the computing systems 602 and online wagering-game server 606 work together such that a computing system 602 can be operated as a thin, thick, or intermediate client. For example, one or more elements of game play may be controlled by the computing system 602 (client) or the online wagering-game server 606 (server). Game play elements can include executable game code, lookup tables, configuration files, game outcome, audio or visual representations of the game, game assets or the like. In a thin-client example, the online wagering-game server 406 can perform functions such as determining game outcome or managing assets, while the computing system 602 can present a graphical representation of such outcome or asset modification to the user (e.g., player). In a thick-client example, the computing system 602 can determine game outcomes and communicate the outcomes to the online wagering-game server 606 for recording or managing a player's account.

The computing systems 602 can use various interfaces to display the online gaming site 612. For example, a computing system 602 can include a web browser application. The web browser application is directed to load a URL associated with the online gaming site 612, and the wagering-game content is displayed within the web browser. Other examples of applications that can be used to interface with the online gaming site 612 include native desktop applications and mobile applications.

In some embodiments, either the computing systems 602 (client) or the online wagering-game server 606 can provide functionality that is not directly related to game play. For example, account transactions and account rules may be managed centrally (e.g., by the online wagering-game server 606) or locally (e.g., by the computing system 602). Other functionality not directly related to game play may include power management, presentation of advertising, software or firmware updates, system quality or security checks, etc.

In some embodiments, the offer server 607 can provide functionality that facilitates the selection, display and management of offers. For example, the computing systems 602 can request offers to display from the offer server 607. The offer server 607 can select offers and provide offer data to the computing systems 602. The computing systems 602 can also indicate that an offer has been accepted, notifying the offer server 607. The offer server 607 can store various data about displayed and/or accepted offers. In some embodiments, the online wagering-game server 606 provides the functionality of the offer server 607. Further, in some embodiments, the offer server 407 can include the functionality of a revenue-tracking server either alone or in conjunction with the functionality of an offer server.

Any of the online wagering game network components (e.g., the computing systems 602) can include hardware and machine-readable media including instructions for performing the operations described herein.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

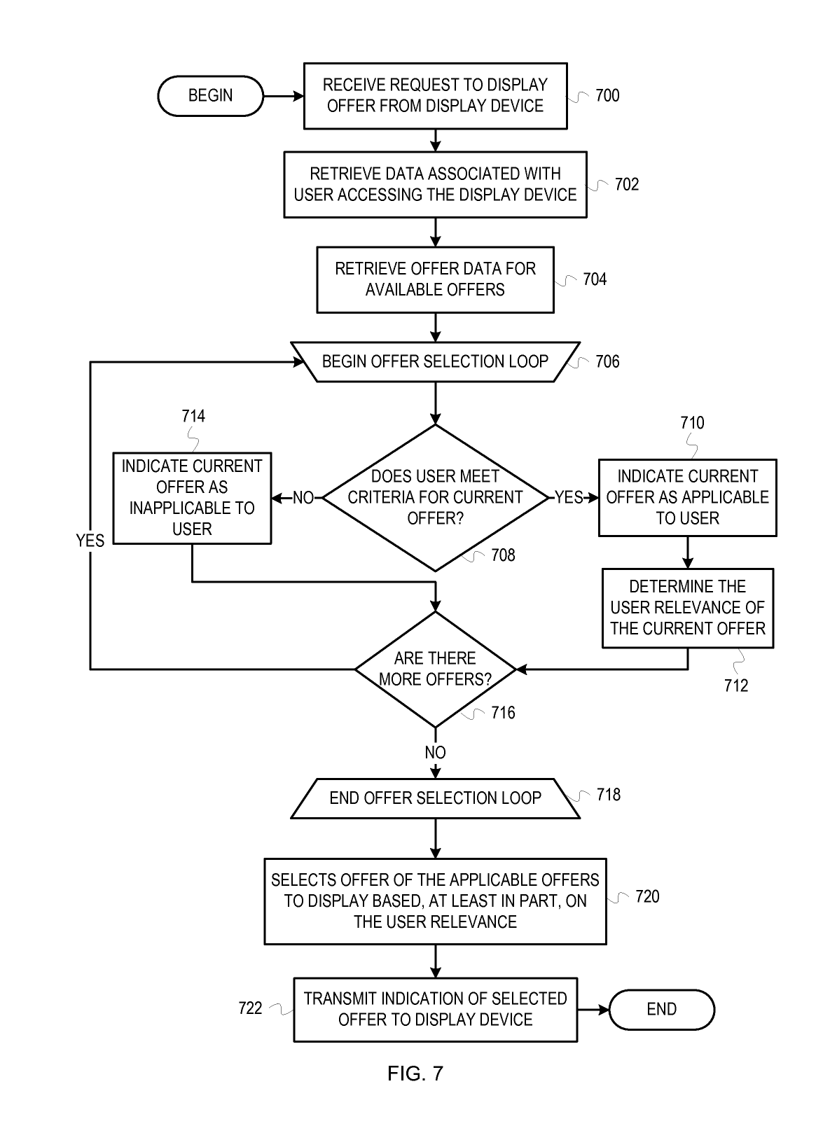

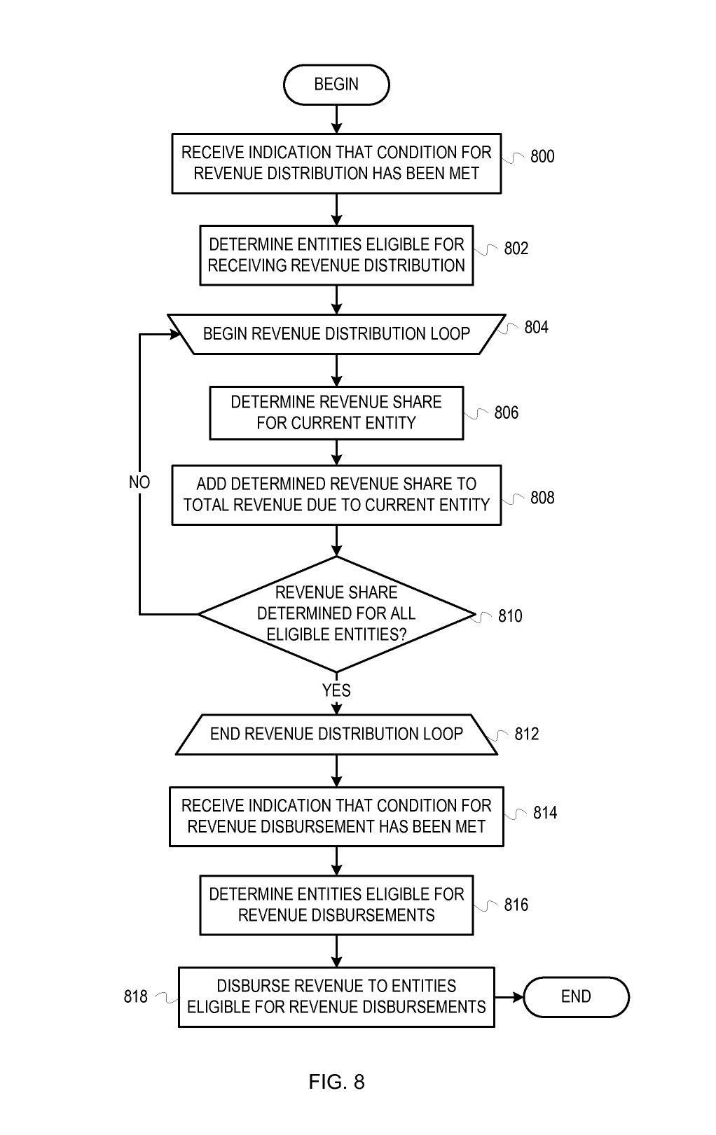

The section will discuss FIGS. 7-8. The discussion of FIG. 7 will describe operations for selecting an offer to display. The discussion of FIG. 8 will describe operations for distributing and disbursing player revenues.

FIG. 7 depicts example operations for selecting an offer for display on an online gaming site or wagering-game machine at a casino.

At block 700, an offer server receives a request to display an offer. The request to display the offer can come from an online gaming site or wagering-game machine (hereinafter “display device”) in response to a player accessing the display device. The player can access the display device by entering authentication information (such as a username and password), swiping a card with a magnetic strip, utilizing a radio frequency identifier, etc. The player can access the display device by navigating to a particular webpage or screen, performing a certain action (such as interacting with a physical input device located on the display device), etc. Thus, for example, the offer server may receive a request to display an offer once, such as when the player initially accesses the display device, or multiple times, such as each time the player accesses a particular screen or performs a certain action. The request to display the offer can include a player identifier, identifying information about how the player is accessing the display device, etc. For example, the request to display the offer can include a device identifier, a page identifier, an action identifier, etc. After the offer server receives the request to display the offer, control flows to block 702.

At block 702, the offer server retrieves data associated with the player accessing the display device. For example, the offer server can query a database containing the data associated with the player accessing the display device. The database can include data associated with all players that can access the display device. The offer server can thus indicate, in a query to the database, the player identifier included in the request to display the offer. The database can then use the player identifier to access and return the data associated with the specific player. After the offer server retrieves the data associated with the player accessing the display device, control then flows to block 704.

At block 704, the offer server retrieves data associated with offers that are available for display. For example, the offer server can query a database containing the data associated with the offers that are available for display. The offer server can indicate data and parameters that limit the offer data retrieved. For example, some offers may only be available to be displayed on certain devices. Thus, the offer server can indicate the device identifier in the query, restricting the offer data to offers that are only available for display on the particular display device. Similarly, player data retrieved at block 702 or at any other time can be used to restrict the offer data returned. For example, the offer server can include an offering entity identifier that restricts the offer data returned to offer data associated with the offering entity. After the offer server retrieves data associated with offers that are available for display, control then flows to block 706.

At block 706, the offer server begins an offer selection loop. To initialize the loop, the offer server selects a current offer from a set of one or more offers retrieved at block 704. During each subsequent iteration, the offer server updates the current offer to the next offer of the set of one or more offer. After the offer server initializes or updates the offer selection loop, control then flows to block 708.

At block 708, the offer server determines whether the player meets criteria for the current offer. Only certain offers may be available for certain players. For example, some offers may only be available to players that spend a certain amount of money over a particular period of time, reside within a particular geographic region, are of a particular age, etc. The specific criteria used can vary between implementations, and can include player demographics, player action histories, etc. Whether the player meets the criteria will vary between implementations based on the specific criteria used. If the offer server determines that the player meets the criteria for the current offer, control flows to block 710. If the offer server determines that the player does not meet the criteria for the current offer, control flows to block 714.

At block 710, the offer server indicates that the current offer is applicable to the player. For example, the offer server may indicate the current offer as applicable by changing the value of a variable associated with the current offer, moving data indicating or representing the current offer from one data structure to another, etc. After the offer server indicates that the current offer is applicable to the player, control then flows to block 712.

At block 712, the offer server determines a player relevance of the current offer. The player relevance of the current offer is an indication of how closely the player matches the criteria for the current offer (i.e., how likely the player is to accept the offer). For example, some mismatches between offer criteria for the current offer and the player might not disqualify the player for the offer completely. Rather, the current offer is deemed applicable based on a first set of criteria, and how closely the player matches a second set of criteria is used to determine how relevant the offer is to the player. For example, while the current offer may only be applicable to players within a particular state, the current offer may be considered more relevant to players that are within a specified age range. The further the age of the player is from the specified age range, the less relevant the current offer is to the player. The specific techniques and data used to determine player relevance can vary between implementations. The player relevance can be represented in a manner that allows for easy comparison to other offers, such as being represented by a naturally ordered value, like an integer. After the offer server determines the player relevance of the current offer, control then flows to block 716.

If, at block 708, the offer server determined that the player does not meet the criteria for the current offer, control flow to block 714. At block 714, the offer server indicates that the current offer is inapplicable to the player. For example, the offer server may indicate the current offer as inapplicable by changing the value of a variable associated with the current offer, moving data indicating or representing the current offer from one data structure to another, removing an indication of or data representing the current offer from a data structure, etc. After the offer server indicates that the current offer is inapplicable to the player, control then flows to block 716.

Control flows to block 716 from block 712 and from block 714. At block 716, the offer server determines whether all offers have been iterated over (i.e., whether there are more offers to consider in the offer selection loop). If not all offers have been iterated over, control then flows back to block 706. If all offers have been iterated over, control then flows to block 718.

At block 718, the offer selection loop is complete. After iterating over all offers retrieved at block 704, the offer server has determined whether each offer is applicable to the player and the player relevance for each offer. After the offer server completes the offer selection loop, control then flows to block 720.

At block 720, the offer server selects which offer of the applicable offers to display based, at least in part, on the player relevance. In some implementations, the offer server selects the offer that is the most relevant to the player, and thus most likely to be accepted. In some implementations, the offer server selects the offer based on additional factors as well. For example, the offer server can take into account the incentive offered by the offering entity. Thus, the offer server may select an offer that has a lower player relevance but a greater incentive (i.e., revenue share). Similarly, the offer server can determine the probability of offer acceptance based on the player relevance of each offer. The offer server can then multiply the incentive value of each offer by the respective probability of offer acceptance to calculate an expected value of each offer. The offer server can then select an offer based on the expected value of each offer. After the offer server selects which offer of the applicable offers to display, control then flows to block 722.

At block 722, the offer server transmits an indication of the selected offer to the display device. For example, the offer server can transmit an offer identifier to the display device. The offer server can then use the offer identifier to retrieve the offer data. The offer server can also transmit a resource address, such as a uniform resource locator (URL) that refers to an image associated with the offer. The offer server can also transmit a URL that refers to a target page that is displayed when the player clicks on a link associated with the offer. After transmitting the indication of the selected offer to the display device, the process ends.

Many of the operations described in FIG. 7 can be performed in different orders, and not all operations may be performed in all implementations. For example, the operations performed at block 708 can be performed as part of the operations performed to retrieve the offer data at block 704. For example, a database query can restrict the offer data returned by including the relevant player data in the query itself. Similarly, the database can determine the player relevance either by embedding the calculations used in the query, using a stored procedure, etc. Thus, in some implementations, it is possible that the operations described in block 706 through block 718 are not performed by the offer server. Many other variations are possible, and not all permutations are described herein.

FIG. 8 depicts example operations for distributing and disbursing player revenue among associated entities.

At block 800, a revenue tracking and disbursement server receives an indication that a condition for revenue distribution has been met. The condition for revenue distribution can vary between implementations, and can comprise multiple individual conditions. For example, the incentive for an offer can be a flat fee when the offer is accepted, and the offer is accepted when a player clicks an advertisement for the offer. Thus, the condition for revenue distribution can be the clicking of the advertisement. If the incentive for an offer is a percentage of money spent by a player at an offering entity, the condition for revenue distribution can be a purchase by the player at the offering entity. Further, additional conditions can be added such that revenue is only distributed once the player spends a certain amount at the offering entity. Thus, the condition for revenue distribution would not be met until the player spent money at the offering entity and the total amount of money spent by the player at the offering entity reached the specified amount. After the revenue tracking and disbursement server receives the indication that the condition for revenue distribution has been met, control then flows to block 802.

At block 802, the revenue tracking and disbursement server determines which entities are eligible for receiving revenue distributions. In some implementations, only the offering entity is eligible for receiving revenue distributions associated with a particular offer. In some implementations, however, multiple entities are eligible for receiving revenue distributions associated with a particular offer. For example, consider an online gaming site. Entity A is a casino that a player visited. During the visit, Entity A referred the player to the online gaming site. Later, the player accepts an offer at Entity B, another casino, to purchase twenty dollars of gameplay at the online gaming site for the cost of ten dollars. Because both Entity A and Entity B referred the player to the online casino, both may be entitled to an amount of the revenue generated from the offer. Furthermore, the online gaming site could be viewed as an entity as well. In other words, instead of viewing the online gaming site as receiving the entire revenue, then distributing a portion of the revenue to Entity A and Entity B, the revenue distribution can be viewed as a portion of the revenue being distributed to the online gaming site, Entity A, and Entity B. In the latter view, no single entity receives the entirety of the revenue generated from the offer.

Regardless of how revenue recognition is viewed, the revenue tracking and disbursement server can determine the entities eligible for receiving revenue distribution by querying a database or performing a similar operation. The various entities that are eligible for receiving revenue distributions are generally determined for the particular player that accepted an offer; however, implementations can vary. For example, one or more entities may get a revenue distribution from all accepted offers, regardless of whether the player is explicitly associated with the one or more entities. In some implementations, the specific entities that are eligible for a revenue distribution can be stored statically, such that any action that changes which entities are eligible for revenue distributions updates the related data when the action occurs. In some implementations, the specific entities that are eligible for revenue distribution are determined dynamically. In some implementations, a combination of static storage and dynamic determination of eligible entities is used. For example, data representing the fact that Entity A originally referred the player in the example above may be stored statically, while the revenue tracking and disbursement server determines at the time the condition for revenue distribution has been met that Entity B is associated with the offer and is therefore eligible for revenue distribution. After the revenue tracking and disbursement server determines which entities are eligible for receiving revenue distributions, control then flows to block 804.

At block 804, the revenue tracking and disbursement server begins a revenue distribution loop. In the revenue distribution loop, the revenue tracking and disbursement server iterates over each entity that is eligible for revenue distribution and determines how much revenue is distributed to the particular entity. To initialize the loop, the revenue tracking and disbursement server selects one entity of the eligible entities as the current entity. For each additional pass through the loop, the revenue tracking and disbursement server selects the next entity of the eligible entities as the current entity. After the revenue tracking and disbursement server initializes or updates the current entity, control then flows to block 806.

At block 806, the revenue tracking and disbursement server determines the revenue share for the current entity. When only one entity is eligible for the revenue distribution, the revenue tracking and disbursement server determines whether the revenue share is a flat fee, percentage of money spent, etc. for the single entity. However, when multiple entities are eligible for the revenue distribution, many variations can arise. For example, Entity A may receive a flat fee from the revenue generated by the offer, Entity B may receive a percentage of the entire amount of revenue generated by the offer, and Entity C may receive a percentage of any revenue left over after all other entities receive their revenue share. Further, some entities may have priority over other entities, as illustrated by Entity A receiving its revenue share before any other entity. Thus, the revenue tracking and disbursement server solves priority issues that exist between the eligible entities. Some implementations may restrict the variations available, while others may permit even more options that described, and thus not all possible permutations are described herein. After the revenue tracking and disbursement server determines the revenue share for the current entity, control then flows to block 808.

At block 808, the revenue tracking and disbursement server adds the determined revenue share for the current entity to the total revenue due to the current entity. Thus, if the determined revenue share for the current entity is five dollars and the total revenue due to the current entity is one hundred dollars, the revenue tracking and disbursement server would add the five dollars to the total, resulting in one hundred and five dollars in total revenue due to the current entity. After the revenue tracking and disbursement server adds the determined revenue share for the current entity to the total revenue due to the current entity, control then flows to block 810.

At block 810, the revenue tracking and disbursement server determines whether the revenue share for all eligible entities has been determined. If the revenue tracking and disbursement server determines that the revenue share for all eligible entities has been determined, control then flows to block 810. If the revenue tracking and disbursement server determines that not all revenue shares for the eligible entities have been determined, control flows back to block 804.

At block 812, the revenue distribution loop ends. At the end of the revenue distribution loop, the revenue share for all eligible entities has been determined. Further, the revenue share for all eligible entities has been added to the total revenue due to each respective entity. After the revenue distribution loop ends, control then flows to block 814.

At block 814, the revenue tracking and disbursement server receives an indication that a condition for revenue disbursement has been met. Revenue disbursement is the act of paying an entity the revenue that is due to the entity, as opposed to recording that revenue should be distributed to the entity, as described above. The condition for revenue disbursement can vary between implementations. For example, revenue can be disbursed each time revenue is distributed, thus the condition for disbursement can be the distribution of revenue to a particular entity. Revenue can be disbursed periodically, such as monthly, and thus the condition for disbursement can be a period of time variously delineated. Revenue can be disbursed whenever the total revenue due to an entity reaches a predetermined amount, thus the condition for disbursement can be revenue due to an entity exceeding the predetermined amount. Further, the condition for revenue disbursement can comprise multiple conditions for disbursement. For example, revenue may only be disbursed monthly to entities having total revenue due to the entity that is over the predetermined amount, thus the condition for disbursement comprises an elapsed time period and the total amount of revenue due the entity exceeding the predetermined amount. Thus, revenue can be disbursed to multiple entities at once in batches, to individual entities on demand, or a combination thereof. After the revenue tracking and disbursement server receives the indication that the condition for revenue disbursement has been met, control then flows to block 816.

At block 816, the revenue tracking and disbursement server determines which entities are eligible for revenue disbursements. The technique used to determine which entities are eligible for revenue disbursements can vary between implementations. For example, if revenue is disbursed to all entities that have revenue due, the revenue tracking and disbursement server may determine which entities are eligible for revenue disbursement by determining all entities that are due revenue. If a particular entity requests a disbursement of revenue, the revenue tracking and disbursement server determines which entity requested the disbursement. Generally, the technique used to determine which entities are eligible for revenue disbursements will vary based on the particular conditions for revenue disbursement supported by a particular implementation. After the revenue tracking and disbursement server determines which entities are eligible for revenue disbursements, control then flows to block 818.

At block 818, the revenue tracking and disbursement server disburses revenue to the entities eligible for revenue disbursements. The technique used to disburse revenue to the entities eligible for revenue disbursement can vary between implementations. For example, the revenue tracking and disbursement server can initiate electronic wire transfers from one bank account to another bank account, print out bank drafts for each entity, etc. After the revenue tracking and disbursement server disburses revenue to the entities eligible for revenue disbursement, the process ends.

Many of the operations described in FIG. 8 can be performed in different orders, and not all operations may be performed in all implementations. For example, the revenue tracking and disbursement server can loop over all entities during the revenue distribution loop illustrated at block 804 through block 812. Thus, the operations performed at block 802 can be part of the revenue distribution block. Additionally, in implementations where revenue is disbursed immediately upon being distributed to an entity, the operations at blocks 808, and 816 may not be performed, while the operations at block 814 may be the same as the operations at block 800. Many other variations are possible, and not all permutations are described herein. Further, while FIGS. 7 and 8 refer to an offer server and a revenue tracking and disbursement server, the offer server may embody some or all functionality of the revenue tracking and disbursement server. A revenue tracking and disbursement server may embody some or all functionality of the offer server.

### Player-Provider Affiliation Examples

This section describes various examples of player-provider affiliations and management of the player-provider affiliations.

In some embodiments, player-provider affiliation for each player is limited to the original referring provider. For example, the first casino to refer a particular player to an online gaming provider can be the sole affiliated provider for that player. Thus, any revenue generated by the player at the online gaming provider is shared solely with the first casino for the life of the player. However, this presents a particular challenge: the ability to incentivize other casinos to refer the player to the online gaming provider is reduced or eliminated. For example, providing another offer for the online gaming provider through any casino other than the original referring casino would be difficult, as no incentive would be available to any other casino. Thus, if the player did not return to the first casino, there would be little opportunity to draw the player back to the online gaming provider. However, there are some player-provider affiliation techniques that can alleviate these challenges.

First, limiting affiliations to a particular time limit can incentivize the original referring provider to continue referring the player to the offering provider (in order to renew the affiliation) while allowing other providers to receive incentives for referring the player, if the player stops returning to the original referring provider. Second, an affiliation can be perpetual unless another provider refers the player to the offering provider. In other words, the original referring provider receives the sole revenue share until a second referring provider refers the player to the offering provider, at which point the second referring provider receives the sole revenue share, and so on. Such an implementation provides a constant impetus for a referring provider to continue referring the player back to the offering provider. Such an implementation, however, is subject to providers desiring to not give up all compensation for referrals. However, there are many other permutations that can allow a referring provider to maintain at least some portion of the revenue share, while still providing incentives to other providers.

For example, an offering provider can designate a certain fee or percentage for a maximum revenue share, say fifty percent of all revenue generated from the player, for example. The original referring provider receives the full fifty percent revenue share until an additional referring provider refers the player to the offering provider. The original referring provider receives a reduced revenue share for each additional referring provider. For example, upon a referral from a second referring provider, the original referring provider's revenue share falls to twenty-five percent. The revenue share can be split evenly among referring providers such that the particular revenue share for each referring provider is dependent upon the number of referring providers. Other protections for the original referring provider can be built in. For example, the revenue share for an original referring provider can be subject to a floor, such that the revenue share does not fall below the floor value. In the above example, the original referring provider may have a revenue sharing floor of twenty-five percent. Thus, the original referring provider will always receive twenty-five percent of the revenue, while additional referring providers split the remaining twenty-five percent revenue share. Further, the various revenue shares for multiple referring providers can be weighted based on various factors, such as when each respective referring provider referred the player or how much revenue from the player each respective provider is responsible for. For example, the original referring provider can receive the largest percentage of a revenue share, while each additional referring provider receives a smaller percentage than the previous referring provider. The reverse can be implemented such that the most recent referring provider receives the largest percentage of the revenue share, and the oldest referring provider receives the least.

Many of the above implementations can be combined. For example, each player-provider affiliation in a multiple provider revenue share can expire after a certain time period unless renewed by another referral from the particular referring provider. Other implementations beyond those described herein are also possible, and not all permutations are described herein.

### Example Offers and Revenue Tracking

This section describes various examples of implementations that are possible with the embodiments described herein. While many general examples of offers were described above, there are additional, more specific offers that can be utilized by some embodiments of the inventive subject matter.

Some offers described above are of the type where the offering provider pays the referring provider a percentage of revenue spent by the player. When an online gaming provider refers a player to a casino with such an offer, tracking the amount of revenue spent by the player can be difficult unless there is some manner to tie the player to each transaction. For example, if a player uses cash to pay for services at the casino, there may be no indication that the particular player is associated with the offer or the transactions. However, most loyalty programs offered by casinos use some form of identification, such as a card with a magnetic strip that is swiped for each transaction. Thus, in some embodiments, offers can be restricted to players that are associated with loyalty programs at the casinos, which provide for techniques to track revenue directly associated with the player.

Further, offers can be allowed or restricted based on location. For example, casino A might be the first casino to refer a particular player to an online gaming provider, and thus restrict offers shown to the player to those associated with casino A. However, if the online gaming provider determines that the player is outside of a predetermined distance from casino A, the online gaming provider may be allowed to display offers for casinos near the player. Thus, the online gaming provider is not restricted to only displaying offers for casino A when the player is too far from casino A to take advantage of an offer for casino A.

Some online gaming providers are associated with entities that control, own, or lease wagering-game machines. In some scenarios, the entities receive a percentage of the revenue generated by the associated machines. Offers can be restricted such that they are only redeemable on wagering-game machines that are associated with the online gaming providers and provide a percentage of the revenue generated by the associated machines. This ensures that at least some revenue generated by the deal is returned to the online gaming provider.

Players can also be incentivized to use specific wagering-game machines at a casino without specifically restricting the player to redeeming the deal on the specific wagering-game machines. For example, some wagering games reward players by allowing access to additional game content as the player plays a particular wagering game. More specifically, for example, a player may unlock an additional “level” with different game elements and payouts after playing for a certain length of time or spending a certain amount of money. Some specific wagering-game machines can be synchronized with the online gaming provider so that the content unlocked by the player at the online gaming provider is also available on specific wagering-game machines. Thus, the player may be more likely to play the games that have the unlocked content. Similarly, when the player plays at a synchronized wagering-game machine, any additional content unlocked will also be available at the online gaming provider. The wagering-game machines can be synchronized for the particular player when the player provides some form of identification, such as a username and password or loyalty card that is known to the online gaming provider.

Some wagering games allow a player to accrue points for gameplay. Points can be redeemed for a variety of rewards, such as free gameplay, prizes, etc. Players can be incentivized to play specific wagering-game machines by offering increased rates of point accrual at those specific wagering-game machines. For example, the online gaming provider might provide one reward point for each turn played. However, the player can be given three reward points for each turn played at the specific wagering-game machines.

Revenue generated by players at a casino can be tracked by various methods, such as using a loyalty program card, as described above. However, some revenue might not be readily trackable. For example, purchases of food and drinks may not be tracked by a loyalty program. However, the player can be provided a receipt for each purchase that includes a redemption code. The online gaming provider can then offer incentives to enter the redemption code on the online gaming site, such as additional points. When a player enters in a redemption code, the online gaming provider can indicate that the online gaming provider is due revenue from the purchase associated with the redemption code.

Many other implementations of offers and techniques of tracking revenue are possible, depending on many factors, such as the relationship between each entity involved, technology available to each entity, player behavior, etc. Not all possible implementations and permutations are described herein.

### Implementation Variations

Other variations of the inventive subject matter consistent with the descriptions herein can be implemented. For example, a computer can receive an indication from another computer, via a network, that an offer has been accepted by a player. The computer can determine information about the player and a wagering game provider associated with the offer. The computer can further determine a group of wagering game providers associated with the player (that does not include the aforementioned wagering game provider). The computer can also determine an amount of revenue to distribute to both the single wagering game provider and the group.

The amount of revenue to distribute to the single wagering game provider and the group can be based on revenue derived from the player. Further, the amount of revenue can be split evenly between all providers. Further, the amount of revenue can be a percentage of revenue derived from the player and/or a flat fee.

As described above, the amount of revenue can be split between the providers in various manners. For example, the single wagering game provider might receive a greater amount of revenue than each wagering game provider of the group. The amount of revenue to be distributed to each of the wagering game providers can also be based on one or more weights. The weights assigned to each of the providers can be based on how recently the offer was accepted (and/or how recently offers for each of the providers were accepted).

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A computing system comprising:
revenue-distribution-logic circuitry comprising one or more processors and one or more memory devices, the one or more memory devices storing instructions that, when executed by the one or more processors, cause the revenue-distribution-logic circuitry to:
determine that a condition has been met for distributing revenue associated with offers made to wagering game players;
determine, by querying one or more electronic data stores, wagering game providers that are eligible to receive the revenue;
determine amounts of the revenue for each of the wagering game providers; and
distribute the amounts of the revenue to the wagering game providers.

2. The computing system of claim 1, wherein the instructions that cause the revenue-distribution-logic circuitry to determine the wagering game providers that are eligible to receive the revenue comprise instructions that, when executed by the one or more processors, cause the revenue-distribution-logic circuitry to:
determine one or more of the wagering game players associated with each of the offers;
determine, by querying the one or more electronic data stores, that no other offers have been more recently accepted by the wagering game players; and
determine, by querying the one or more electronic data stores, that the wagering game providers are associated with the offers.

3. The computing system of claim 1, wherein the instructions further comprise instructions that, when executed by the one or more processors, cause the revenue-distribution-logic circuitry to:
determine that a predetermined time period has passed; and
after a determination that the predetermined time period has passed, indicate that at least one of the wagering game providers is no longer eligible to receive the revenue.

4. The computing system of claim 1, wherein the instructions further comprise instructions that, when executed by the one or more processors, cause the revenue-distribution-logic circuitry to:
receive an indication that an additional offer has been accepted by a wagering game player of the wagering game players; and
in response to the reception of an indication that the additional offer has been accepted by the wagering game player, indicate that a wagering game provider associated with the additional offer is eligible to receive the revenue.

5. The computing system of claim 1, wherein the instructions further comprise instructions that, when executed by the one or more processors, cause the revenue-distribution-logic circuitry to indicate that at least one of the wagering game providers is no longer eligible to receive the revenue.

6. The computing system of claim 1, wherein the condition for the revenue distribution comprises at least one of an indication that at least one of the offers was accepted and an indication that the amounts of revenue for each of the wagering game providers exceeds a predetermined threshold.

7. The computing system of claim 6, wherein the indication that at least one of the offers was accepted comprises at least one of an indication of a user action, an indication that at least of the offers has been redeemed, and an indication that a purchase associated with at least one of the offers was made.

8. A computer-implemented method for distributing amounts of revenue to wagering game providers, the method comprising:
determining, by one or more processors of a computing system, that a condition has been met for distributing the revenue, wherein the revenue is associated with offers made to wagering game players, wherein an indication that the condition has been met is stored in at least one of one or more registers, cache memory, and system memory;
determining, by querying one or more electronic data stores, the wagering game providers, wherein the wagering game providers are eligible to receive the revenue;
determining, by the one or more processors of the computing system, the amounts of the revenue for each of the wagering game providers; and
distributing the amounts of the revenue to the wagering game providers.

9. The computer-implemented method of claim 8, wherein the determining the wagering game providers that are eligible to receive the revenue comprises:
determining one or more of the wagering game players associated with each of the offers;
determining, by querying the one or more electronic data stores, that no other offers have been more recently accepted by the wagering game players; and
determining, by querying the one or more electronic data stores, that the wagering game providers are associated with the offers.

10. The computer-implemented method of claim 8 further comprising:
determining that a predetermined time period has passed; and
after determining that the predetermined time period has passed, indicating that at least one of the wagering game providers is no longer eligible to receive the revenue.

11. The computer-implemented method of claim 8 further comprising:
receiving an indication that an additional offer has been accepted by a wagering game player of the wagering game players; and
in response to receiving the indication that the additional offer has been accepted by the wagering game player, indicating that a wagering game provider associated with the additional offer is eligible to receive the revenue.

12. The computer-implemented method of claim 11 further comprising indicating that at least one of the wagering game providers is no longer eligible to receive the revenue.

13. The computer-implemented method of claim 8, wherein the condition for the revenue distribution comprises at least one of an indication that at least one of the offers was accepted and an indication that the amounts of revenue for each of the wagering game providers exceeds a predetermined threshold.

14. The computer-implemented method of claim 13, wherein the indication that at least one of the offers was accepted comprises at least one of an indication of a user action, an indication that at least of the offers has been redeemed, and an indication that a purchase associated with at least one of the offers was made.

15. A computer-implemented method for making offers to wagering game players, the method comprising:
determining to display an offer at a computing device, wherein the offer is associated with an offer provider and a wagering game presented on the computing device;
retrieving, from one or more electronic data stores, data associated with a player of the wagering game and data associated with a plurality of offers, wherein at least one of the data associated with the player of the wagering game and the data associated with the plurality of offers is stored in at least one of one or more registers, cache memory, and system memory after being retrieved;
selecting the offer from the plurality offers based, at least in part, on the data associated with the plurality of offers and the data associated with the player;
sending an indication of the offer to the computing device;
receiving, from the computing device, an indication that the offer has been accepted by the player; and
determining, after the offer has been accepted by the player, that a revenue share is to be paid to the offer provider, wherein the revenue share is based, at least in part, on the offer.

16. The computer-implemented method of claim 15, wherein the data associated with the player of the wagering game comprises at least one of demographic data and player history data, wherein the player history data comprises at least one of a wagering game history and an offer acceptance history.

17. The computer-implemented method of claim 15, wherein the data associated with the plurality of offers comprises criteria for determining at least one of a relevance of each of the plurality of offers to the player and a player acceptance probability for each offer of the plurality of offers.

18. The computer-implemented method of claim 15, further comprising:
for each offer of the plurality of offers,
determining that the player meets one or more criteria for the offer; and
in response to determining that the player meets the one or more criteria for the offer, indicating that the offer is applicable to the player;
wherein said selecting the offer is based, at least in part, on the indication that the offer is applicable to the player.

19. The computer-implemented method of claim 18, further comprising:
for each offer of the plurality of offers, determining a relevance of the offer to the player based, at least in part, on the data associated with the player and the data associated with the plurality of offers;
wherein said selecting the offer is based, at least in part, on the determined relevance of the offer.

20. The computer-implemented method of claim 15, wherein said selecting the offer from the plurality of offers comprises selecting the offer of the plurality of offers based, at least in part, on an incentive value of the offer of the plurality of offers.
